(19) United States
(12) Patent Application Publication
(10) Pub. No.: US 2020/0005242 A1
(43) Pub. Date: Jan. 2, 2020

(54) PERSONALIZED MESSAGE INSIGHT GENERATION

(71) Applicant: Microsoft Technology Licensing, LLC, Redmond, WA (US)

(72) Inventors: Harsha Badami Nagaraj, Sunnyvale, CA (US); Peter Hume Rigano, San Francisco, CA (US); Srividya Krishnamurthy, Sunnyvale, CA (US); Sahin Cem Geyik, Redwood City, CA (US); Yufei Wang, Holmdel, NJ (US)

(21) Appl. No.: 16/021,297

(22) Filed: Jun. 28, 2018

(51) Int. Cl. G06Q 10/10; H04L 12/58; H04L 29/08

(52) U.S. Cl. CPC G06Q 10/107; G06Q 50/01; H04L 67/306; H04L 51/32

(57) ABSTRACT

Disclosed are systems, methods, and non-transitory computer-readable media for generating personalized insights. An insight generation system, in response to a first user of an online service having added a second user as a recipient of a message, gathers profile data of the second user and profile data of an entity that is maintained by the online service. The insight generation system determines a set of insights for the second user, based on the profile data of the second user, the profile data of the entity, and a set of insight algorithms. Each insight indicates commonalities between the second user and the entity. The insight generation system selects a subset of the set of insights, yielding a set of recommended insights, and provides the set of recommended insights to a client device of the first user.

### TECHNICAL FIELD

An embodiment of the present subject flatter relates generally to messages and, more specifically, to personalized message insight generation.

### BACKGROUND

Many online services enable users to communicate with each other by transmitting electronic messages. For example, an online service may provide a messaging interface in which users may draft and transmit messages to other users. This can be particularly useful for recruiters that wish to reach out to potential candidates to fill available employments positions. While online messaging functionality is convenient, it still requires a user to spend a considerable amount of time drafting a personalized message. For example, a recruiter will have to spend considerable time researching a candidate to draft an effective personalized message. Some users may opt to reuse a message to save time; however, this results in a generic message that is not as effective as personalized messages. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system, wherein a messaging system includes an insight generation system that generates personalized insights, according to some example embodiments.

FIG. 2 is a block diagram of the messaging system, according to some example embodiments.

FIG. 3 is a block diagram of the insight generation system, according to some example embodiments.

FIG. 4 is a flowchart showing an example method of generating personalized message insights, according to certain example embodiments.

FIG. 5 is a flowchart showing an example method of generating personalized message insights, according to certain example embodiments.

FIGS. 6A and 6B are a screenshot of a messaging interface including a set of personalized insights, according to some example embodiments.

FIG. 7 is a block diagram illustrating an example software architecture, which may be used in conjunction with various hardware architectures herein described.

FIG. 8 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for generating personalized message insights. Generating personalized messages is a time intensive task. For example, to draft a personalized message to a potential candidate, a recruiter spends significant time reviewing the candidate's profile, identifying potential points of connection between the candidate and the available position, and writing text conveying the points of connection. While this is an effective form of communication, drafting messages in this manner is also time consuming and inefficient. For example, a recruiter tasked with filling many roles is limited in the number of personalized messages they can send daily due to the time and effort it takes to draft each message. Previous solutions to this issue include the reuse of a single message that a user can quickly copy and paste. While this allows a drafting user (i.e., the user drafting the message) to generate and transmit more messages, the messages are generic and not personalized to each recipient user (i.e., the user that is the recipient of the message), resulting in the messages being less effective.

To alleviate this issue, a messaging system may utilize an insight generation system that automatically generates personalized insights that a user may quickly include in their message to a recipient user. A personalized insight is a text (e.g., sentence, multiple sentences, paragraph, etc.) that conveys a connection between the recipient user and a target entity. A target entity is any type of entity (e.g., business, service, job opening, cause, etc.) about which the message is meant to generate interest with the recipient user. For example, a personalized insight may be a text indicating why a recipient user is a good fit for an available job. As another example, a personalized insight may be a text indicating why a recipient user would like or should visit a restaurant. As another example, a personalized insight may be a text indicating why a recipient user would be supportive of a proposed law or political candidate.

The insight generation system generates personalized insights based on profile data associated with the recipient user and the entity. The profile data may be profile data maintained by a social networking service with which both the recipient user and the entity have an account or designated profile. The profile data may include a variety of information about the recipient user and the entity, such as address, work history, likes, dislikes, and so forth. The profile data may also include historical use data of the recipient user and/or entity indicating messages that were transmitted and/or sent, as well as whether responses were received to the transmitted messages.

The insight generation system uses the profile data of the recipient user and/or the entity as input in insight algorithms, which provide resulting personalized insights. An insight algorithm is an algorithm (e.g., series of steps, formula, etc.) that is performed to generate a personalized insight. An insight algorithm dictates specific profile data to be gathered, data to be compared, thresholds for determining an insight, and so forth, to determine a personalized insight. For example, a simple insight algorithm may dictate a series of steps to determine a number of employees at a company that are connected with the recipient user on a social networking service. The insight algorithm may dictate gathering data indicating connections of the user on the social networking service and searching the connections of the recipient user for users that are employees of the company. The result of performing the insight algorithm is a personalized insight that indicates a connection between the recipient user and the company (i.e., a number of connections of the recipient user that work at the company).

The insight generation system selects a subset of the generated personalized insights to present to the drafting user while he/she is drafting a message. The insight generation system generates text that conveys a determined personalized insight, which the drafting user can select to include in the message they are drafting to the recipient user. For example, the generated text may be “We think you would he a good fit for our company because you have 5 connections that currently work here.” The personalized insights may he copied and pasted into the text of the message by the drafting user. Alternatively, the personalized insight may be selectable, such that the drafting user may click on the personalized insight to cause the personalized insight to be inserted into the message.

Rather than present each generated personalized insight to the drafting user, the insight generation system selects a subset of the personalized insights. This reduces computing resource usage by reducing the amount of data transmitted between devices, as well as results in an improved user interface that is not cluttered with an overwhelming amount of data. The insight generation system may select a subset of personalized insights based on multiple factors, such as how likely the personalized insight is to influence the recipient user, how likely the recipient user is to respond to the personalized insight, how likely the drafting user is to select the personalized insight for inclusion in the message, and the like. These factors can he determined in multiple ways, such as based on the historical user data of the recipient user (e.g., what types of insights the recipient user has responded to in the past), a determined degree to which an insight exceeds one or more thresholds, historical use data of the drafting user drafting (e.g., what types of insights does the drafting user select to include in messages), and so forth.

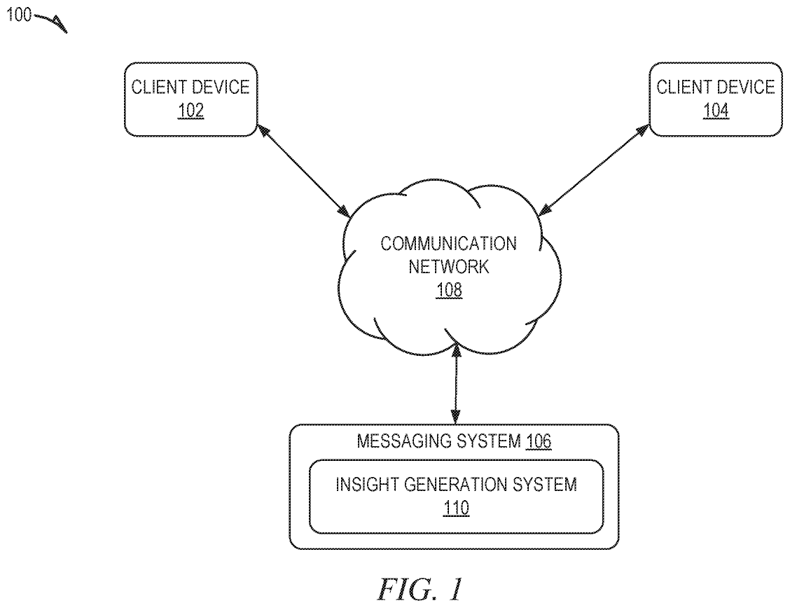

FIG. 1 shows a system 100, wherein a messaging system 106 includes an insight generation system 110 that generates personalized insights, according to some example embodiments. The messaging system 106 provides the personalized insights to a drafting user as recommendations that the drafting user can include in a message transmitted to a recipient user.

As shown, multiple devices (i.e., client device 102, client device 104, and a messaging system 106) are connected to a communication network 108 and configured to communicate with each other through use of the communication network 108. The communication network 108 is any type of network, including a local area network (LAN), such as an intranet, a wide area network (WAN), such as the internet, or any combination thereof. Further, the communication network 108 may be a public network, a private network, or a combination thereof. The communication network 108 is implemented using any number of communications links associated with one or more service providers, including one or more wired communication links, one or more wireless communication links, or any combination thereof. Additionally, the communication network 108 is configured to support the transmission of data formatted using any number of protocols.

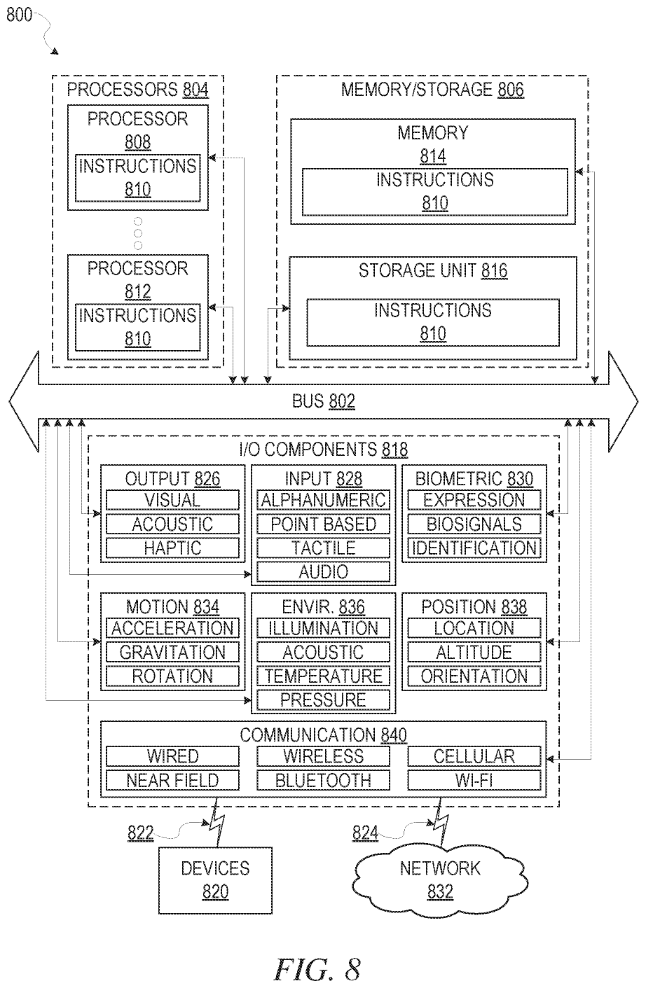

Multiple computing devices can be connected to the communication network 108. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 800 shown in FIG. 8.

To facilitate communication with other computing devices, a computing device includes a communication interface configured to receive a communication, such as a request, data, and so forth, from another computing device in network communication with the computing device and pass the communication along to an appropriate module running on the computing device. The communication interface also sends a communication to another computing device in network communication with the computing device.

In the system 100, users interact with the messaging system 106 to establish and participate in communication sessions with other users. For example, users use the client devices 102 and 104 that are connected to the communication network 108 by direct and/or indirect communication to communicate with and utilize the functionality of the messaging system 106. Although the shown system 100 includes only two client devices 102, 104, this is only for ease of explanation and is not meant to be limiting. One skilled in the art would appreciate that the system 100 can include any number of client devices 102, 104. Further, the messaging system 106 may concurrently accept connections from and interact with any number of client devices 102, 104. The messaging system 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, etc.

A user interacts with the messaging system 106 via a client-side application installed on the client devices 102 and 104. In some embodiments, the client-side application includes a messaging system specific component. For example, the component may be a stand-alone application, one or more application plug-ins, and/or a browser extension. However, the users may also interact with the messaging system 106 via a third-party application, such as a web browser, that resides on the client devices 102 and 104 and is configured to communicate with the messaging system 106. In either case, the client-side application presents a user interface (UI) for the user to interact with the messaging system 106. For example, the user interacts with the messaging system 106 via a client-side application integrated with the file system or via a webpage displayed using a web browser application.

The messaging system 106 is one or more computing devices configured to facilitate and manage communication sessions between various client devices 102, 104. The messaging system 106 can be a standalone system or integrated into other systems or services, such as being integrated into an online service, such as a social networking service, new service, and so forth. In either case, the messaging system 106 facilitates a communication session between client devices 102 and 104, where a user using one client device 102 can send messages to and receive messages from another user using another client device 104.

The messaging system 106 enables a user to initiate a communication session by providing a messaging interface where the user can select other users to include in the communication session, draft messages to be transmitted to the selected other users as part of a communication session, and read messages received from the other users as part of the communication sessions. Messages transmitted by a user's client device 102 as part of a communication session are received by the messaging system 106, which forwards the message to the recipient user's client device 104. The messaging system 106 can also store the received messages along with metadata describing the messages, such as the time the messages were sent, the originating user of the message, the recipient of the message, and the like.

The messaging system 106 includes an insight generation system 110 that enables the messaging system 106 to generate personalized insights. The messaging system 106 provides the personalized insights to a drafting user (i.e., a user drafting a message) as recommended text for inclusion in a message being drafted by the drafting user.

A personalized insight is a text (e.g., sentence, multiple sentences, paragraph, etc.) that conveys a connection between a recipient user (i.e., the user that is the identified recipient of a message that is being drafted) and a target entity. A target entity is any type of entity (e.g., business, service, job opening, cause, etc.) in which the message is meant to generate interest with the recipient user. For example, a personalized insight may be a text indicating why a recipient user is a good fit for an available job. As another example, a personalized insight may be a text indicating why a recipient user would like or should visit a restaurant. As another example, a personalized insight may be a text indicating why a recipient user would be supportive of a proposed law or political candidate.

The insight generation system 110 generates personalized insights based on profile data associated with the recipient user and the entity. As explained, the messaging system 108 may be incorporated as part of an online service (not shown), such as a social networking service, that allows users to create user accounts. Each user account includes profile data associated with the user, such as the user's demographic data (e.g., address, age, race, income, employment history, etc.), preference data (e.g., the user's likes, the user's dislikes, etc.), as well as the user's historical use data (e.g., messages transmitted/received by the user, posts made by the user, profiles viewed by the user, etc.). Likewise, an entity may also have a user account. For example, a user profile may be created for a company, cause, and so forth. The user accounts for an entity also include profile data associated with the entity, such as demographic, preference, historical user data.

The insight generation system 110 uses the profile data of the user and/or the entity as input in insight algorithms, which provide resulting personalized insights. An insight algorithm is an algorithm (e.g., series of steps, formula, etc.) that is performed to generate a personalized insight. An insight algorithm dictates specific profile data to be gathered, data to be compared, thresholds for determining an insight, and so forth, for determining a personalized insight. For example, a simple insight algorithm may dictate a series of steps to determine a number of employees at a company that are connected with a recipient user on a social networking service. The insight algorithm may dictate gathering data indicating connections of the recipient user on the social networking service and searching the connections of the recipient user for users that are employees of the company. The result of performing the insight algorithm is a personalized insight that indicates a connection between the recipient user and the company (i.e., a number of connections of the recipient user that work at the company).

The insight generation system 110 selects a subset of the generated personalized insights to present to the drafting user while he/she is drafting a message. The insight generation system 110 generates text that conveys a determined personalized insight, which the drafting user can select to include in the message they are drafting to the recipient user. For example, the generated text may be “We think you would be a good fit for our company because you have 5 connections that currently work here,” The personalized insights may be copied and pasted into the text of the message by the drafting user. Alternatively, the personalized insight may be selectable, such that the drafting user may click on the personalized insight to cause the personalized insight to be inserted into the message.

Rather than present each generated personalized insight to the drafting user, the insight generation system 110 selects a subset of the personalized insights. This reduces computing resource usage by reducing the amount of data transmitted between devices (e.g., messaging system 106, client device 102, and client device 104), as well as results in an improved user interface that is not cluttered with an overwhelming amount of data. The insight generation system 110 may select a subset of personalized insights based on multiple factors, such as how likely the personalized insight is to influence the recipient user, how likely the recipient user is to respond to the personalized insight, how likely the drafting user is to select the personalized insight for inclusion in the message, and so forth. These factors can be determined in multiple ways, such as based on the historical user data of the recipient user (e.g., what types of insights the recipient user has responded to in the past), a determined degree to which an insight exceeds one or more thresholds, historical use data of the drafting user drafting (e.g., what types of insights does the drafting user select to include in messages), and so forth.

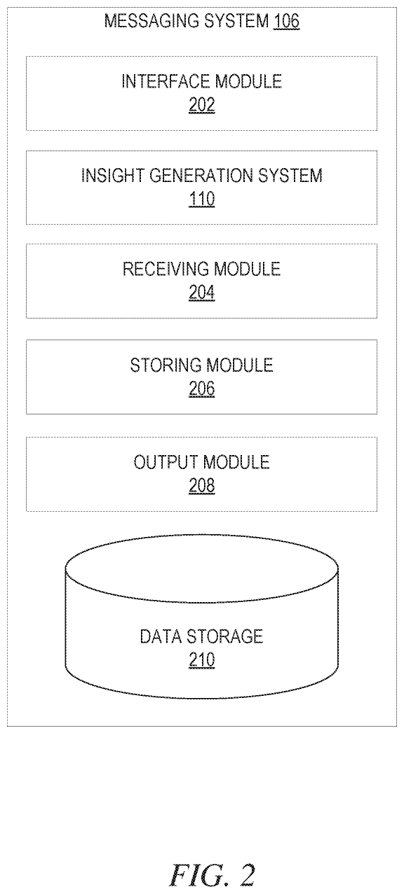

FIG. 2 is a block diagram of the messaging system 106, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the messaging system 106 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the messaging system 106 includes an interface module 202, an insight generation system 110, a receiving module 204, a storing module 206, an output module 208, and a data storage 210. The interface module 202 provides a messaging interface that enables users to initiate and participate in communication sessions with other users. For example, the messaging interface includes user interface elements (e.g., buttons, scrollbars, text fields, etc.) that enable a user to select users and draft messages to initiate and participate in a communication session. Further, the messaging interface presents the users with a listing of available contacts to include in a communication session. The messaging interface also presents the user with a listing of existing communication sessions, which a user can select from to read the previous messages transmitted as part of the communication session as well as to draft and send new messages as part of the communication session.

The insight generation system 110 generates personalized insights for a drafting user. A personalized insight is a text (e.g., sentence, multiple sentences, paragraph, etc.) that conveys a connection between the recipient user of a message and a target entity of the message. A target entity is any type of entity (e.g., business, service, job opening, cause, etc.) in which the message is meant to generate interest with the recipient user. For example, a personalized insight may be a text indicating why a recipient user is a good fit for an available job. As another example, a personalized insights may be a text indicating why a recipient user would like or should visit a restaurant. As another example, a personalized insight may be a text indicating why a recipient user would be supportive of a proposed law or political candidate.

The insight generation system 110 generates personalized insights in response to receiving an indication that a drafting user is drafting a message to the recipient user. For example, the indication may be the result of the drafting user using the messaging interface to add the recipient user as a recipient of a message being drafted. As another example, the indication may be the result of the drafting user selecting a user interface element to receive insights. For example, the messaging interface may include user interface elements that a drafting user may select to indicate that they would like to draft a message to a specified recipient user and/or select to request that personalized insights be generated for the specified recipient user.

The insight generation system generates personalized insights based on profile data associated with the recipient user and the entity. The messaging system 106 and insight generation system 110 may be implemented as part of an online service that allows users to create user accounts. For example, the online service may be a social networking service, such as LinkedIn, Facebook, and so forth. A user account maintains user profile data of the users, such as demographic data, preference data, historical use data, and the like. For example, the profile data may include a variety of information about the recipient user and the entity, such as address, work history, likes, dislikes, and the like. The historical use data of the recipient user and/or entity includes data indicating messages that were transmitted and/or sent, as well as whether responses were received to the transmitted messages.

The profile data is stored in the data storage 210, where it is associated with its corresponding user account. That is, the profile data is associated with a unique identifier associated with the user account. The insight generation system 110 communicates with the data storage 210 to gather appropriate profile data to generate personalized insights. For example, the insight generation system 110 uses unique identifiers of the recipient user and the entity to gather the appropriate profile data from the data storage 210.

The insight generation system 110 uses the profile data of the recipient user and/or the entity as input in insight algorithms, which provide resulting personalized insights. An insight algorithm is an algorithm (e.g., series of steps, formula, etc.) that is performed to generate a personalized insight. An insight algorithm dictates specific profile data to be gathered, data to be compared, thresholds for determining an insight, and the like, to determine a personalized insight. For example, a simple insight algorithm may dictate a series of steps to determine a number of employees at a company that are connected with the recipient user on a social networking service. The insight algorithm may dictate gathering profile data from the data storage 210 that indicates connections of the recipient user on the social networking service, and searching the connections of the recipient user for users that are employees of the company. The result of performing the insight algorithm is a personalized insight that indicates a connection between the recipient user and the company (i.e., a number of connections of the recipient user that work at the company).

The insight generation system 110 selects a subset of the generated personalized insights to present to the drafting user while he/she is drafting a message to the recipient user. The insight generation system 110 generates text that conveys a determined personalized insight, which the drafting user can select to include in the message they are drafting to the recipient user. For example, the generated text may be “We think you would be a good fit for our company because you have 5 connections that currently work here.”

The insight generation system 110 provides the personalized insights to the drafting user's client device 102, 104. For example, the insight generation system 110 provides the generated insights to the interface module 202, which causes the personalized insights to be presented on a display of the drafting user's client device 102, 104. The drafting user can use the presented personalized insights by copying and pasting them into the text of the message that the drafting user is drafting to the recipient user. Alternatively, the personalized insight may be selectable, such that the drafting user may click on the personalized insight to cause the personalized insight to be inserted into the message.

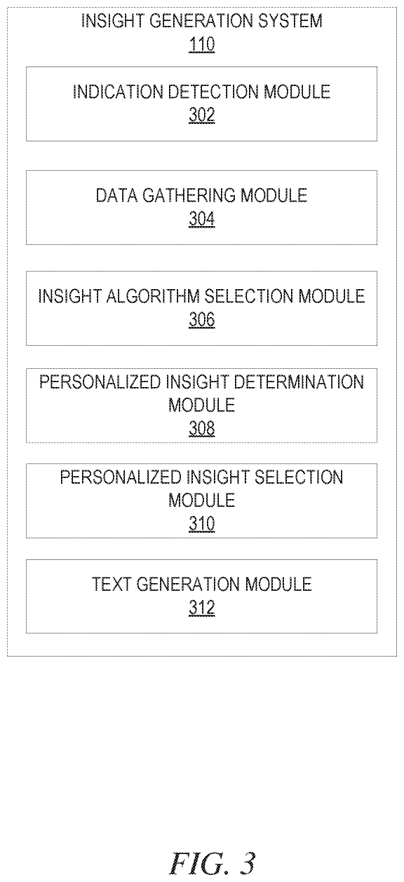

Rather than present each generated personalized insight to the drafting user, the insight generation system 110 selects a subset of the personalized insights. This reduces computing resource usage by reducing the amount of data transmitted between devices (e.g., messaging system 106, client device 102, and client device 104), as well as results in an improved user interface that is not cluttered with an overwhelming amount of data. The insight generation system 110 may select a subset of personalized insights based on multiple factors, such as how likely the personalized insight is to influence the recipient user, how likely the recipient user is to respond to the personalized insight, how likely the drafting user is to select the personalized insight for inclusion in the message, and so forth. These factors can he determined in multiple ways, such as based on the historical user data of the recipient user (e.g., what types of insights the recipient user has responded to in the past), a determined degree to which an insight exceeds one or more thresholds, historical use data of the drafting user drafting (e.g., what types of insights does the drafting user select to include in messages), and so forth. The functionality of the insight generation system 110 is discussed in greater detail below in relation to FIG. 3.

The receiving module 204 receives messages that are being transmitted as part of a communication session. The messages are received from the client device 102, 104 of a drafting user and intended for one or more other client devices 102, 104 of recipient users in the communication session. For example, a drafting user may use the client device 102 to generate and transmit a message to the client device 104 of a recipient user as part of a communication session. The message is initially received by the receiving module 204 of the messaging system 106. The received messages may include metadata, such as a timestamp indicating the time at which the message was transmitted, identifiers identifying the source and/or destination client devices 102, 104, an identifier identifying the communication session, and the like.

The storing module 206 stores message data consisting of the received messages along with associated metadata in the data storage 210. In some embodiments, the storing module 206 anonymizes the message data to protect the privacy of the users. For example, the storing module 206 removes names and other personal information from the message data. The storing module 206 may also store the message data for a limited period of time, after which the message data is deleted. In some embodiments, a user is allowed to opt in or opt out of having their message data stored by the storing module 206. Accordingly, users that do not want to have their message data stored can opt out, resulting in the storing module 206 not storing their message data

The output module 208 transmits received messages to a recipient user's client device (e.g., client device 104) as part of a communication session. The recipient user can use their client device (e.g., client device 104) to respond to the received message.

FIG. 3 is a block diagram of the insight generation system 110, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the insight generation system 110 to facilitate additional functionality that is not specifically described herein. Furthermore, the various functional modules depicted in FIG. 3 may reside on a single computing device or may be distributed across several computing devices in various arrangements such as those used in cloud-based architectures.

As shown, the insight generation system 110 includes an indication detection module 302, a data gathering module 304, an insight algorithm selection module 306, a personalized insight determination module 308, a personalized insight selection module 310, and a text generation module 312.

The indication detection module 302 detects indications that a drafting user has added a recipient user to a message. This may be the result of a drafting user using the message interface to add a recipient user as a recipient user of a message. For example, the drafting user may enter the recipient user's name into a text field, select the recipient user from a listing of contacts, and so forth. Alternatively, the messaging interface may include user interface elements that a user may select to initiate drafting a message to a recipient user. For example, the messaging interface may include user interface elements on profile pages of the users of the online service that a user may select to initiate a message to the selected user and/or select to request that personalized insights be generated for a specified recipient user.

In some embodiments, a user may be able to select whether to opt into or out of the functionality of the insight generation system 110. For example, a recruiter may select to opt into having personalized insights generated for their messages. Accordingly, the indication detection module 302, as well as the other modules of the insight generation system 110, will perform their functionality when a user has selected to opt in. As a result, the indication detection module 302 will not detect recipient users being added to messages by a drafting user that does not wish to have personalized insights presented to them.

The insight generation system 110 generates personalized insights in response to detecting that a drafting user has added a recipient user to a message. Accordingly, the indication detection module 302 module provides data describing the recipient user and the entity associated with a message to the data gathering module 304 upon detection that a drafting user has added a recipient user to a message. The data may include unique account identifiers associated with the recipient user and the entity. The unique account identifiers identify the recipient user and entity's user accounts on an online service. The data gathering module 304 uses the received unique account identifiers to communicate with the data storage 210 and gather the corresponding profile data.

The insight algorithm selection module 306 selects a set of insight algorithms to use for generating personalized insights for the recipient user. An insight algorithm is an algorithm (e.g., series of steps, formula, etc.) that is performed to generate a personalized insight. An insight algorithm dictates specific profile data to be gathered, data to be compared, thresholds for determining an insight, and the like, to determine a personalized insight. The insight generation system 110 maintains a pool of insight algorithms in the data storage 210. Rather than performing each of the insight algorithms, the insight algorithm selection module 306 selects a subset of the insight algorithms. This reduces computing resources needed to generate personalized insights, thereby increasing the speed at which a computing device determines personalized insights.

In some embodiments, the insight algorithm selection module 306 selects the subset of insight algorithms based on whether there is sufficient data to properly perform the insight algorithm. Each insight algorithm is associated with data requirements for performing the respective insight algorithm. The data requirement indicates the data needed to properly perform the insight algorithm. For example, an insight algorithm that determines a number of connections of a recipient user that work at a specified company may have data requirements of a listing of the connections of the recipient user and a listing of the employees of the company. That is, the listing of the connections of the recipient user and a listing of the employees of the entity are needed to perform the steps of the insight algorithm.

The insight algorithm selection module 306 uses the data requirements of the insight algorithms and the profile data gathered by the data gathering module 304 to identify insight algorithms for which there is or is not sufficient data to perform the steps of the algorithm. The insight algorithm selection module 306 may filter out any insights algorithm for which there is insufficient data, thereby reducing the number of insights algorithms used to determine personalized insights.

In addition to filtering insight algorithms based on whether there is sufficient data to perform the algorithm, the insight algorithm selection module 306 may also filter insight algorithms based on other factors, such as how likely the drafting user is to select the personalized insights generated by the insight algorithms. For example, the insight algorithm selection module 306 uses historical use data of the drafting user to identify personalized insights that the drafting user has either not selected in past or has rarely selected in the past. The insight algorithm selection module 306 can then filter out the corresponding insight algorithms.

The insight algorithm selection module 306 provides the resulting subset of insights algorithms (i.e., the insight algorithms that were not filtered out) to the personalized insight determination module 308. The personalized insight determination module 308 uses the subset of insight algorithms and the data gathered by the data gathering module 304 to determine a set of personalized insights for the recipient user. That is, the personalized insight determination module 308 uses the data to perform the steps of the insight algorithms, which results in the set of personalized insights.

The personalized insight selection module 310 selects a subset of the generated personalized insights to present to the drafting user. Limiting the number or personalized insights presented to the user reduces computing resources associated with transmitting data, as well as improves the user interface by reducing clutter associated with presenting data.

The personalized insight selection module 310 selects the subset of personalized insights based in numerous ways. For example, the personalized insight selection module 310 may select personalized insights that are most likely to be persuasive to the recipient user. To accomplish this, the personalized insight selection module 310 may determine a degree to which the personalized insights exceed a threshold value. For example, a personalized insight such as the number of connections of the recipient user that work at a company may be more persuasive if the number is higher. Some of the insight algorithms may include a threshold value, which the personalized insight selection module 310 uses to determine a degree to which the threshold value has been exceeded. The threshold value can be predetermined (e.g., assigned to the insight algorithm) or determined based on historical data. For example, the threshold values can be an average, mean, and the like, of other users. The personalized insight selection module 310 determines a degree to which these thresholds are exceeded. For example, the personalized insight selection module 310 determines a number by which the threshold is exceeded or a percentage of the threshold by which it is exceeded. The personalized insight selection module 310 may then select the personalized insights that exceed the threshold by the greatest degree to be presented to the drafting user.

The personalized insight selection module 310 may also select personalized insights based on historical user data of the recipient user. For example, the personalized insight selection module 310 can use the historical user data to identify specific personalized insights or types of personalized insights that the recipient user has responded to in the past. These types of personalized insights may be of greater influence on the recipient user. Accordingly, the personalized insight selection module 310 selects any personalized insights to which the recipient user is likely to respond for presentation to the drafting user.

Likewise, the personalized insight selection module 310 may select personalized insights based on historical user data of the drafting user. For example, the personalized insight selection module 310 can use the historical user data to identify specific personalized insights or type of personalized insights that the drafting user has included in messages in the past. Accordingly, the personalized insight selection module 310 selects any personalized insights that the drafting user is likely to include in a message.

The personalized insight selection module 310 may also select personalized insights from different categories. For example, the personalized insights may be categorized, such as personalized insights that indicate why a recipient user would like an offered job, why the company is a good fit, and so forth. The personalized insight selection module 310 may select personalized insights from different categories to provide the drafting user with a variety of options when drafting the message.

The text generation module 312 generates text that conveys the generated personalized insights. For example, the text generation module 312 may include a set of one or more templates for each personalized insight. Each template may include a variable portion that is filled in based on the determined personalized insight.

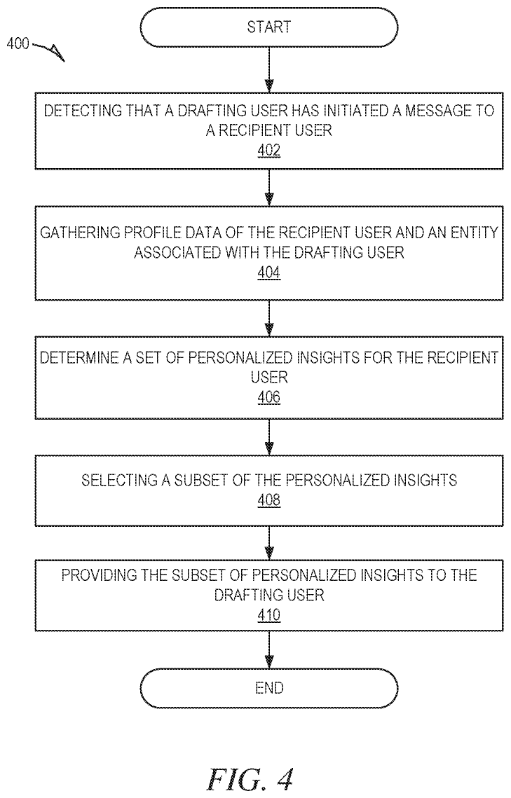

FIG. 4 is a flowchart showing an example method 400 of generating personalized message insights, according to certain example embodiments. The method 400 may be embodied in computer readable instructions for execution by one or more processors such that the operations of the method 400 may be performed in part or in whole by the insight generation system 110; accordingly, the method 400 is described below by way of example with reference thereto. However, it shall be appreciated that at least some of the operations of the method 400 may be deployed on various other hardware configurations and the method 400 is not intended to be limited to the insight generation system 110.

At operation 402, the indication detection module 302 detects that a drafting user has initiated a message to a recipient user. For example, the drafting user may have entered the recipient user's name into a text field, selected the recipient user from a listing of contacts, and the like. Alternatively, the messaging interface may include user interface elements that a user may select to initiate drafting a message to a recipient user. For example, the messaging interface may include user interface elements on profile pages of the users of the online service that a user may select to initiate a message to the selected user and/or select to request that personalized insights be generated for a specified recipient user.

The indication detection module 302 module provides data describing the recipient user and the entity associated with a message to the data gathering module 304 upon detection that a drafting user has added a recipient user to a message. The data may include unique account identifiers associated with the recipient user and the entity. The unique account identifiers identify the recipient user and entity's user accounts on an online service.

At operation 404, the data gathering module 304 gathers profile data of the recipient user and an entity associated with the drafting user. The data gathering module 304 uses the received unique account identifiers to communicate with the data storage 210 and gather the corresponding profile data.

At operation 406, the personalized insight determination module 308 determines a set of personalized insights for the recipient user. The personalized insight determination module 308 uses the data gathered by the data gathering module 304 to perform a set of insight algorithms to determine the set of personalized insights for the recipient user. That is, the personalized insight determination module 308 uses the profile data to perform the steps of the insight algorithms, which results in the set of personalized insights.

At operation 408, the personalized insight selection module 310 selects a subset of the personalized insights. Limiting the number or personalized insights presented to the user reduces computing resources associated with transmitting data, as well as improves the user interface by reducing clutter associated with presenting data.

The personalized insight selection module 310 selects the subset of personalized insights based in numerous ways. For example, the personalized insight selection module 310 may select personalized insights that are most likely to be persuasive to the recipient user. To accomplish this, the personalized insight selection module 310 may determine a degree to which the personalized insights exceed a threshold value. For example, a personalized insight such as the number of connections of the recipient user that work at a company may be more persuasive if the number is higher. Some of the insight algorithms may include a threshold value, which the personalized insight selection module 310 uses to determine a degree to which the threshold value has been exceeded. The threshold value can be predetermined (e.g., assigned to the insight algorithm), or determined based on historical data. For example, the threshold values can be an average, mean, and the like, of other users. The personalized insight selection module 310 determines a degree to which these thresholds are exceeded. For example, the personalized insight selection module 310 determines a number by which the threshold is exceeded or a percentage of the threshold by which it is exceeded. The personalized insight selection module 310 may then select the personalized insights that exceed the threshold by the greatest degree to be presented to the drafting user.

The personalized insight selection module 310 may also select personalized insights based on historical user data of the recipient user. For example, the personalized insight selection module 310 can use the historical user data to identify specific personalized insights or types of personalized insights that the recipient user has responded to in the past. These types of personalized insights may be of greater influence to the recipient user. Accordingly, the personalized insight selection module 310 selects any personalized insights that the recipient user is likely to respond to for presentation to the drafting user.

Likewise, the personalized insight selection module 310 may select personalized insights based on historical user data of the drafting user. For example, the personalized insight selection module 310 can use the historical user data to identify specific personalized insights or type of personalized insights that the drafting user has included in messages in the past. Accordingly, the personalized insight selection module 310 selects any personalized insights that the drafting user is likely to include in a message.

The personalized insight selection module 310 may also select personalized insights from different categories. For example, the personalized insights may be categorized, such as personalized insights that indicate why a recipient user would like an offered job, why the company is a good fit, and so forth. The personalized insight selection module 310 may select personalized insights from different categories to provide the drafting user with a variety of options when drafting the message.

At operation 410, the insight generation system 110 provides the subset of personalized insights to the drafting user. For example, the insight generation system 110 causes the subset of personalized insights to be presented to the user in a messaging interface.

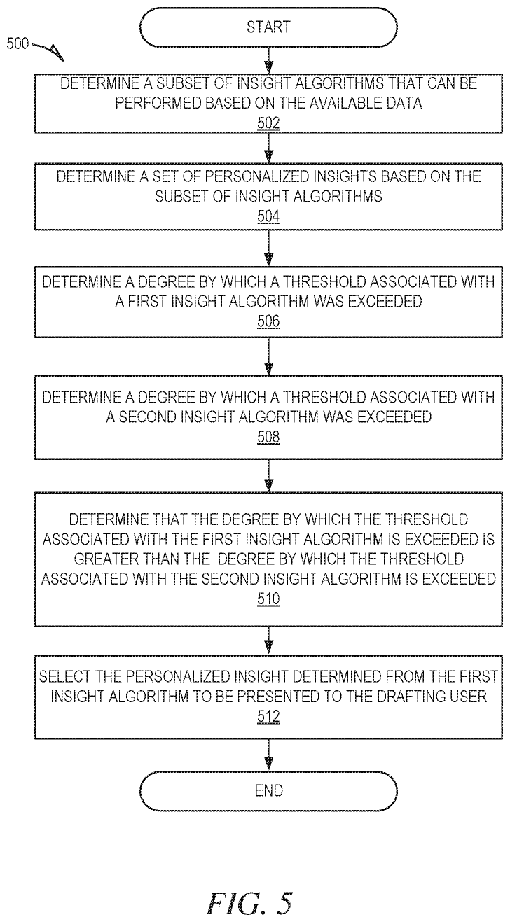

FIG. 5 is a flowchart showing an example method 500 of generating personalized message insights, according to certain example embodiments. The method 500 may be embodied in computer readable instructions for execution by one or more processors such that the operations of the method 500 may be performed in part or in whole by the insight generation system 110; accordingly, the method 500 is described below by way of example with reference thereto. However, it shall be appreciated that at least some of the operations of the method 500 may be deployed on various other hardware configurations and the method 500 is not intended to be limited to the insight generation system 110.

At operation 502, the insight algorithm selection module 306 determines a subset of insight algorithms that can be performed based on the available data. An insight algorithm is an algorithm (e.g., series of steps, formula, etc.) that is performed to generate a personalized insight. An insight algorithm dictates specific profile data to be gathered, data to be compared, thresholds for determining an insight, and so forth, to determine a personalized insight. The insight generation system 110 maintains a pool of insight algorithms in the data storage 210. Rather than performing each of the insight algorithms, the insight algorithm selection module 306 selects a subset of the insight algorithms. This reduces computing resources needed to generate personalized insights, thereby increasing the speed at which a computing device determines personalized insights.

In some embodiments, the insight algorithm selection module 306 selects the subset of insight algorithms based on whether there is sufficient data to properly perform the insight algorithm. Each insight algorithm is associated with data. requirements for performing the respective insight algorithm. The data requirement indicates the data needed to properly perform the insight algorithm. For example, an insight algorithm that determines a number of connections of a recipient user that work at a specified company may have data requirements of a listing of the connections of the recipient user and a listing of the employees of the company. That is, the listing of the connections of the recipient user and a listing of the employees of the entity are needed to perform the steps of the insight algorithm.

The insight algorithm selection module 306 uses the data requirements of the insight algorithms and the profile data gathered by the data gathering module 304 to identify insight algorithms for which there is or is not sufficient data to perform the steps of the algorithm. The insight algorithm selection module 306 may filter out any insights algorithm for which there is insufficient data, thereby reducing the number of insights algorithms used to determine personalized insights.

In addition to filtering insight algorithms based on whether there is sufficient data to perform the algorithm, the insight algorithm selection module 306 may also filter insight algorithms based on other factors, such as how likely the drafting user is to select the personalized insights generated by the insight algorithms. For example, the insight algorithm selection module 306 uses historical use data of the drafting user to identify personalized insights that the drafting user has either not selected in past or has rarely selected in the past. The insight algorithm selection module 306 can then filter out the corresponding insight algorithms.

The insight algorithm selection module 306 provides the resulting subset of insights algorithm (i.e., the insight algorithms that were not filtered out) to the personalized insight determination module 308.

At operation 504, the personalized insight determination module 308 determines a set of personalized insights based on the subset of insight algorithms. The personalized insight determination module 308 uses the subset of insight algorithms and the data gathered by the data gathering module 304 to determine a set of personalized insights for the recipient user. That is, the personalized insight determination module 308 uses the data to perform the steps of the insight algorithms, which results in the set of personalized insights.

At operation 506, the personalized insight selection module 310 determines a degree by which a threshold associated with a first insight algorithm was exceeded. A personalized insight, such as the number of connections of the recipient user that work at a company, may be more persuasive if the number is higher. Accordingly, the personalized insight selection module 310 selects personalized insights that exceed thresholds by a higher degree.

The first insight algorithm is associated with a threshold value. The threshold value can be predetermined (e.g., assigned to the insight algorithm), or determined based on historical data. For example, the threshold values can be an average, mean, and the like, of other users. The personalized insight selection module 310 determines a degree to which the threshold is exceeded. For example, the personalized insight selection module 310 determines a number by which the threshold is exceeded or a percentage of the threshold by which it is exceeded.

At operation 508, the personalized insight selection module 310 determines a degree by which a threshold associated with a second insight algorithm was exceeded.

At operation 510, the personalized insight selection module 310 determines that the degree by which the threshold associated with the first insight algorithm is exceeded is greater than the degree by which the threshold associated with the second insight algorithm is exceeded.

At operation 512, the personalized insight selection module 310 selects the personalized insight determined from the first insight algorithm to be presented to the user. The personalized insight selection module 310 selects the personalized insight determined from the first insight algorithm in response to determining that the degree by which the threshold associated with the first insight algorithm is exceeded is greater than the degree by which the threshold associated with the second insight algorithm is exceeded.

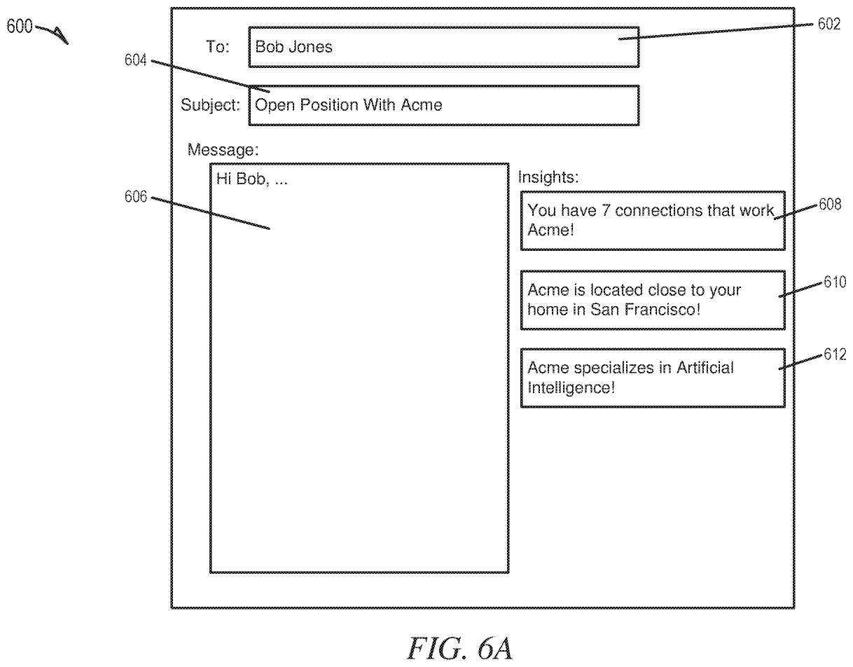

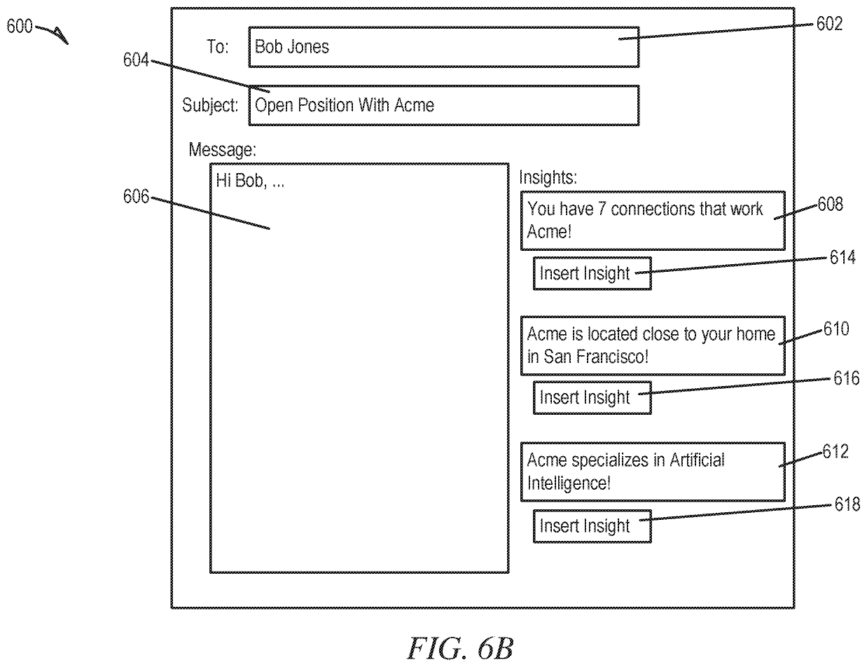

FIGS. 6A and 6B are a screenshot of a messaging interface 600 including a set of personalized insights, according to some example embodiments. As shown, in FIG. 6A, the messaging interface 600 includes a text field 602 that enables a drafting user to enter a recipient user to receive a message. For example, the drafting user enters the recipient user's name, email address, or other identifier into the text field 602. As shown, Bob Jones has been designated as the recipient user of the message. The messaging interface 600 also includes a text field 604 that enables the drafting user to enter a message subject. As shown, the message subject has been entered as “Open Position with Acme.” The messaging interface 600 further includes a text field 606 that enables a user to enter the text of the message.

To aid the drafting user in drafting the message to the recipient user, the messaging interface 600 includes three personalized insights 608, 610, and 612 that the drafting user can include in the message. Each personalized insight indicates a relationship between the recipient user (i.e., Bob Jones) and the entity associated with the message (i.e., Acme). For example, the first personalized insight 608 indicates that the recipient user is connected with 7 people that work at Acme. Similarly, the second personalized insight 610 indicates that the recipient user lives near the Acme offices. Finally, the third personalized insight indicates that Acme specializes in Artificial Intelligence, which may be something that the recipient user also likes or has experience with.

The drafting user may include any of the personalized insights 608, 610, and 612 in the message being drafted to the recipient user. For example, the drafting user may type out any of the personalized insights 608, 610, and 612 in the text field 606 for the message. Alternatively, the drafting user may copy and paste any of the personalized insights 608, 610, and 612 into the text field 606 for the message.

FIG. 6B shows another embodiment of the messaging interface 600 that includes user interface elements 614, 616, and 618 that the drafting user can use to cause a personalized insight to be entered into the text of the message. As shown, each personalized insight 608, 610, and 612 corresponds to a user interface element 614, 616, and 618. For example, the first personalized insight 608 corresponds to a user interface element 614 that the recipient user can select (e.g., click) to cause the first personalized insight 608 to be entered into the text field 606. Likewise, the recipient user can select the user interface element 616 corresponding to the second personalized insight 610 and/or the user interface element 618 corresponding to the third personalized insight 612 to cause the respective personalized insights to be entered into the text field 606.

### Software Architecture

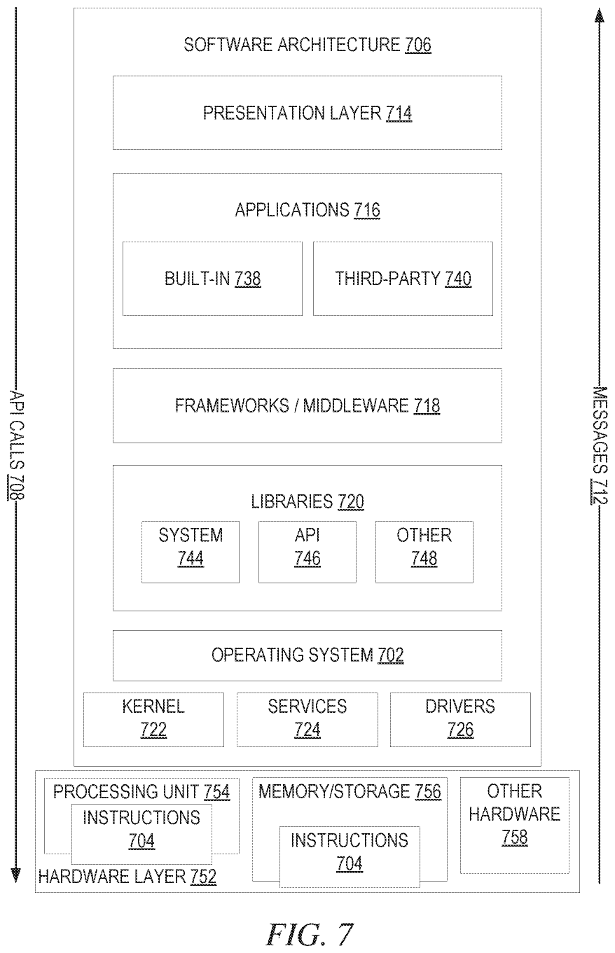

FIG. 7 is a block diagram illustrating an example software architecture 706, which may be used in conjunction with various hardware architectures herein described. FIG. 7 is a non-limiting example of a software architecture 706 and it will he appreciated that many other architectures may be implemented to facilitate the functionality described herein. The software architecture 706 may execute on hardware such as machine 800 of 8 that includes, among other things, processors 804, memory 814, and (input/output) I/O components 818. A representative hardware layer 752 is illustrated and can represent, for example, the machine 800 of FIG. 8. The representative hardware layer 752 includes a processing unit 754 having associated executable instructions 704. Executable instructions 704 represent the executable instructions of the software architecture 706, including implementation of the methods, components, and so forth described herein. The hardware layer 752 also includes memory and/or storage modules 756, which also have executable instructions 704. The hardware layer 752, may also comprise other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716, and a presentation layer 714. Operationally, the applications 716 and/or other components within the layers may invoke API calls 708 through the software stack and receive a response such as messages 712 in response to the API calls 708. The layers illustrated are representative in nature and not all software architectures have all layers. For example, some mobile or special purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 720 provide a common infrastructure that is used by the applications 716 and/or other components and/or layers. The libraries 720 provide functionality that allows other software components to perform tasks in an easier fashion than to interface directly with the underlying operating system 702 functionality (e.g., kernel 722, services 724 and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media format such as MPEG4, H.264, MP3, AAC, AMR, JPG, PING), graphics libraries (e.g., an Opena, framework that may be used to render 2D and 3D in a graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/modules.

The frameworks/middleware 718 (also sometimes referred to as middleware) provide a higher-level common infrastructure that may be used by the applications 716 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may he used by the applications 716 and/or other software components/modules, some of which may be specific to a particular operating system 702 or platform.

The applications 716 include built-in applications 738 and/or third-party applications 740. Examples of representative built-in applications 738 may include, but are not limited to, a contacts application, a browser application, a book reader application, a location application, a media application, a messaging application, and/or a game application. Third-party applications 740 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 740 may invoke the API calls 708 provided by the mobile operating system (such as operating system 702) to facilitate functionality described herein.

The applications 716 may use built in operating system functions (e.g., kernel 722, services 724 and/or drivers 726), libraries 720, and frameworks/middleware 718 to create user interfaces to interact with users of the system. Alternatively, or additionally, in some systems, interactions with a user may occur through a presentation layer, such as presentation layer 714. In these systems, the application/component “logic” can be separated from the aspects of the application/component that interact with a user.

FIG. 8 is a block diagram illustrating components of a machine 800, according to some example embodiments, able to read instructions 704 from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 800 capable of executing the instructions 810, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. In various example embodiments, the 1/0 components 818 may include output components 826 and input components 828. The output components 826 may include visual components (e.g., a display such as a plasma display panel (PUP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environmental components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environmental components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via coupling 824 and coupling 822, respectively. For example, the communication components 840 may include a network interface component or other suitable device to interface with the network 832. In further examples, communication components 840 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 810 for execution by the machine 800, and includes digital or analog communications signals or other intangible medium to facilitate communication of such instructions 810. Instructions 810 may be transmitted or received over the network 832 using a transmission medium via a network interface device and using any one of a number of well-known transfer protocols.

“CLIENT DEVICE” in this context refers to any machine 800 that interfaces to a communications network 832 to obtain resources from one or more server systems or other client devices. A client device 102, 104 may be, but is not limited to, a mobile phone, desktop computer, laptop, PDAs, smart phones, tablets, ultra books, netbooks, laptops, multi-processor systems, microprocessor-based or programmable consumer electronics, game consoles, STBs, or any other communication device that a user may use to access a network 832.

“COMMUNICATIONS NETWORK” in this context refers to one or more portions of a network 832 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 832 or a portion of a network 832 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device, or other tangible media able to store instructions 810 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 810. The term “machine-readable medium” shall also be taken to include any medium, or combination of multiple media, that is capable of storing instructions 810 (e.g., code) for execution by a machine 800, such that the instructions 810, when executed by one or more processors 804 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 804) may be configured by software (e.g., an application 716 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 804 or other programmable processor 804. Once configured by such software, hardware components become specific machines 800 (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 804 configured by software to become a special-purpose processor, the general-purpose processor 804 may be configured as respectively different special-purpose processors (e.g., comprising different hardware components) at different times. Software accordingly configures a particular processor or processors 804, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 802) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 804 that are temporarily configured (e.g., by software) or permanently configured to perform the relevant operations. Whether temporarily or permanently configured, such processors 804 may constitute processor-implemented components that operate to perform one or more operations or functions described herein. As used herein, “processor-implemented component” refers to a hardware component implemented using one or more processors 804. Similarly, the methods described herein may be at least partially processor-implemented, with a particular processor or processors 804 being an example of hardware. For example, at least some of the operations of a method may be performed by one or more processors 804 or processor-implemented components. Moreover, the one or more processors 804 may also operate to support performance of the relevant operations in a “cloud computing” environment or as a “software as a service” (SaaS). For example, at least some of the operations may be performed by a group of computers (as examples of machines 800 including processors 804), with these operations being accessible via a network 832 (e.g., the Internet) and via one or more appropriate interfaces (e.g., an API). The performance of certain of the operations may be distributed among the processors 804, not only residing within a single machine 800, but deployed across a number of machines 800. In some example embodiments, the processors 804 or processor-implemented components may be located in a single geographic location (e.g., within a home environment, an office environment, or a server farm). In other example embodiments, the processors 804 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 800. A processor 804 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 804 (sometimes referred to as “cores”) that may execute instructions 810 contemporaneously.

What is claimed is:

1. A method comprising:
detecting an indication that a first user of an online service has added a second user of the online service as a recipient of a message, wherein the first user is connected with a first entity within the online service and the second user is not connected with the first entity within the online service;
gathering profile data of the second user and profile data of the first entity, the profile data of the second user and the profile data of the first entity being maintained by the online service;
determining, based on the profile data of the second user, the profile data of the first entity, and a set of insight algorithms, a set of insights for the second user, each insight from the set of insights indicating commonalities between the second user and the entity;
selecting a subset of the set of insights, yielding a set of recommended insights; and
providing the set of recommended insights to a client device of the first user, the set of recommended insights usable by the first user to draft the message to the second user.

2. The method of claim 1, wherein determining the set of insights for the second user comprises:
determining, based on data requirements for each insight algorithm of the set of insight algorithms, a subset of insight algorithms that can be performed based on available data included in the profile data of the second user and the profile data of the first entity; and
performing each of the subset of insight algorithms, yielding the set of insights for the second user.

3. The method of claim 1, wherein selecting a subset of insights comprises:
determining that a first threshold dictated by a first insight algorithm was exceeded by a first amount, the first insight algorithm corresponding to a first insight included in the subset of the set of insights;
determining that a second threshold dictated by a second algorithm was exceeded by a second amount, the second insight algorithm corresponding to a second insight included in the subset of the set of insights;
determining that the first amount is greater than the second amount, yielding a first determination; and
selecting the first insight based on the first determination.

4. The method of claim 1, wherein selecting the subset of the set of insights comprises:
gathering historical use data associated with the first user, the historical use data indicating insights previously used by the first user to draft messages;
determining, based on the historical use data, a first likelihood value that the first user will select a first insight included in the subset of the set of insights, and a second likelihood value that the first user will select a second insight included in the subset of the set of insights;
determining that the first likelihood value is greater than the second likelihood value, yielding a first determination; and
selecting the first insight based on the first determination.

5. The method of claim 1, wherein selecting the subset of the set of insights comprises:
gathering historical use data associated with the second user, the historical use data indicating previous messages that the second user has responded to and insights included in the previous messages;
determining, based on the historical use data, a first likelihood value that the first user will respond to messages including a first insight included in the subset of the set of insights, and a second likelihood value that the first user will respond to messages including a second insight included in the subset of the set of insights;
determining that the first likelihood value is greater than the second likelihood value, yielding a first determination; and
selecting the first insight based on the first determination.

6. The method of claim 1, wherein the indication is received as a result of the first user selecting a user interface element to initiate drafting the message to the second user.

7. The method of claim 1, wherein selecting the subset of the set of insights comprises:
selecting at least one insight from a first category of insights and a second category of insights.

8. A system comprising:
one or more computer processors; and
one or more computer-readable mediums storing instructions that, when executed by the one or more computer processors, cause the system to perform operations comprising:
detecting an indication that a first user of an online service has added a second user of the online service as a recipient of a message, wherein the first user is connected with a first entity within the online service and the second user is not connected with the first entity within the online service;
gathering profile data of the second user and profile data of the first entity, the profile data of the second user and the profile data of the first entity being maintained by the online service;
determining, based on the profile data of the second user, the profile data of the first entity, and a set of insight algorithms, a set of insights for the second user, each insight from the set of insights indicating commonalities between the second user and the entity;
selecting a subset of the set of insights, yielding a set of recommended insights; and
providing the set of recommended insights to a client device of the first user, the set of recommended insights usable by the first user to draft the message to the second user.

9. The system of claim 8, wherein determining the set of insights for the second user comprises:
determining, based on data requirements for each insight algorithm of the set of insight algorithms, a subset of insight algorithms that can be performed based on available data included in the profile data of the second user and the profile data of the first entity; and
performing each of the subset of insight algorithms, yielding the set of insights for the second user.

10. The system of claim 8, wherein selecting a subset of insights comprises:
determining that a first threshold dictated by a first insight algorithm was exceeded by a first amount, the first insight algorithm corresponding to a first insight included in the subset of the set of insights;
determining that a second threshold dictated by a second algorithm was exceeded by a second amount, the second insight algorithm corresponding to a second insight included in the subset of the set of insights;
determining that the first amount is greater than the second amount, yielding a first determination; and
selecting the first insight based on the first determination.

11. The system of claim 8, wherein selecting the subset of the set of insights comprises:
gathering historical use data associated with the first user, the historical use data indicating insights previously used by the first user to draft messages;
determining, based on the historical use data, a first likelihood value that the first user will select a first insight included in the subset of the set of insights, and a second likelihood value that the first user will select a second insight included in the subset of the set of insights;
determining that the first likelihood value is greater than the second likelihood value, yielding a first determination; and
selecting the first insight based on the first determination.

12. The system of claim 8, wherein selecting the subset of the set of insights comprises:
gathering historical use data associated with the second user, the historical use data indicating previous messages that the second user has responded to and insights included in the previous messages;
determining, based on the historical use data, a first likelihood value that the first user will respond to messages including a first insight included in the subset of the set of insights, and a second likelihood value that the first user will respond to messages including a second insight included in the subset of the set of insights;
determining that the first likelihood value is greater than the second likelihood value, yielding a first determination; and
selecting the first insight based on the first determination.

13. The system of claim 8, wherein the indication is received as a result of the first user selecting a user interface element to initiate drafting the message to the second user.

14. The system of claim 8, wherein selecting the subset of the set of insights comprises:
selecting at least one insight from a first category of insights and a second category of insights.

15. A non-transitory computer-readable medium storing instructions that, when executed by one or more computer processors of a computing device, cause the computing device to perform operations comprising:
detecting an indication that a first user of an online service has added a second user of the online service as a recipient of a message, wherein the first user is connected with a first entity within the online service and the second user is not connected with the first entity within the online service;
gathering profile data of the second user and profile data of the first entity, the profile data of the second user and the profile data of the first entity being maintained by the online service;
determining, based on the profile data of the second user, the profile data of the first entity, and a set of insight algorithms, a set of insights for the second user, each insight from the set of insights indicating commonalities between the second user and the entity;
selecting a subset of the set of insights, yielding a set of recommended insights; and
providing the set of recommended insights to a client device of the first user, the set of recommended insights usable by the first user to draft the message to the second user.

16. The non-transitory computer-readable medium of claim 15, wherein determining the set of insights for the second user comprises:
determining, based on data requirements for each insight algorithm of the set of insight algorithms, a subset of insight algorithms that can be performed based on available data included in the profile data of the second user and the profile data of the first entity; and
performing each of the subset of insight algorithms, yielding the set of insights for the second user.

17. The non-transitory computer-readable medium of claim 15, wherein selecting a subset of insights comprises:
determining that a first threshold dictated by a first insight algorithm was exceeded by a first amount, the first insight algorithm corresponding to a first insight included in the subset of the set of insights;
determining that a second threshold dictated by a second algorithm was exceeded by a second amount, the second insight algorithm corresponding to a second insight included in the subset of the set of insights;
determining that the first amount is greater than the second amount, yielding a first determination; and
selecting the first insight based on the first determination.

18. The non-transitory computer-readable medium of claim 15, wherein selecting the subset of the set of insights comprises:
gathering historical use data associated with the first user, the historical use data indicating insights previously used by the first user to draft messages;
determining, based on the historical use data, a first likelihood value that the first user will select a first insight included in the subset of the set of insights, and a second likelihood value that the first user will select a second insight included in the subset of the set of insights;
determining that the first likelihood value is greater than the second likelihood value, yielding a first determination; and
selecting the first insight based on the first determination.

19. The non-transitory computer-readable medium of claim 15, wherein selecting the subset of the set of insights comprises:
gathering historical use data associated with the second user, the historical use data indicating previous messages that the second user has responded to and insights included in the previous messages;
determining, based on the historical use data, a first likelihood value that the first user will respond to messages including a first insight included in the subset of the set of insights, and a second likelihood value that the first user will respond to messages including a second insight included in the subset of the set of insights;
determining that the first likelihood value is greater than the second likelihood value, yielding a first determination; and
selecting the first insight based on the first determination.

20. The non-transitory computer-readable medium of claim 15, wherein the indication is received as a result of the first user selecting a user interface element to initiate drafting the message to the second user.
